(19) United States
(12) Patent Application Publication
(10) Pub. No.: US 2026/0236876 A1
(43) Pub. Date: Aug. 13, 2026

(54) COMPUTER-IMPLEMENTED SYSTEM AND METHOD FOR SIMULATION-CALIBRATED ESG INDEX CONSTRUCTION AND RETURN-BASED SUSTAINABILITY ANALYSIS USING HETEROGENEOUS FINANCIAL AND ESG DATA

(71) Applicant: Markov Processes International Inc., Summit, NJ (US)

(72) Inventors: Michael MARKOV, Short Hills, NJ (US); Daniel LI, Millburn, NJ (US); Olga KRASOTKINA, Summit, NJ (US)

(21) Appl. No.: 19/534,204

(22) Filed: Feb. 9, 2026

Related U.S. Application Data
(60) Provisional application No. 63/756,577, filed on Feb. 10, 2025.

(51) Int. Cl. G06Q 10/0639; G06Q 10/0637

(52) U.S. Cl. CPC G06Q 10/06393; G06Q 10/06375

(57) ABSTRACT

A computer system includes one or more processors and non-transitory memory storing instructions that, when executed by the processors, cause the system to perform the following operations: ingesting multi-source datasets comprising security price data, corporate fundamental data, and sustainability data; normalizing and synchronizing the datasets into a time-aligned data structure; performing automated hierarchical data segmentation by sequentially partitioning securities into size-based segments, style-based segments within each size-based segment, and sustainability-based segments within each size-style segment using calibrated thresholds; calibrating the thresholds using a simulation-based calibration engine configured to optimize alignment between holdings-based sustainability measures and return-based factor exposures; constructing sustainability indices for each size-style-sustainability segment; and computing sustainability spread factors based on differences between sustainability indices.

### PRIORITY CLAIM

The present application claims priority to U.S. Provisional Application Ser. No. 63/756,577 filed on Feb. 10, 2025, the entire disclosure of which is incorporated herewith by reference.

### TECHNICAL FIELD

The present disclosure relates to computer-implemented data processing systems for large-scale financial datasets, and more particularly to systems and methods for automated hierarchical data segmentation, simulation-based threshold calibration, dynamic index construction, and return-based sustainability analysis using integrated price, fundamental, and environmental, social, and governance (ESG) datasets.

### BACKGROUND

Environmental, social and governance (ESG) frameworks can be used to evaluate sustainability-related attributes of companies based on reported or derived metrics. In computerized analytics, these company-level sustainability metrics are often transformed into time-series measures for investment products (e.g., portfolios, funds, or benchmarks) to support monitoring, reporting, or consistency checks. Many companies publish ESG reports to demonstrate transparency and to comply with ESG reporting frameworks, standards, regulations, or stakeholder expectations. The types of data included in ESG reporting can vary significantly, including environmental metrics (e.g., emissions, pollution, energy), social metrics (e.g., labor practices, human rights, diversity), and governance metrics (e.g., executive compensation, political contributions, shareholder rights).

Implementations of sustainability analytics commonly rely on heterogeneous datasets that differ in structure, frequency, and coverage, including daily security prices, periodic corporate fundamentals, and sustainability metrics updated at irregular intervals. Computing portfolio-level sustainability exposure measures from these inputs at scale introduces technical challenges in data alignment, segmentation stability, and sensitivity to correlations among sorting characteristics. Existing systems typically apply static thresholds or independent sorting procedures, resulting in correlation leakage, inconsistent segmentation, and limited scalability. Accordingly, there exists a need for an improved sustainability analytics architecture.

### SUMMARY—TO BE COMPLETED WHEN CLAIMS ARE FINALIZED

The present disclosure relates to a computer-implemented method executed by one or more processors for constructing sustainability indices and sustainability spread factors using heterogeneous financial datasets. The method includes ingesting the heterogeneous financial datasets comprising security price data, corporate fundamental data, and sustainability data; normalizing and synchronizing the datasets into a time-aligned data structure; performing automated hierarchical data segmentation on the time-aligned data structure by sequentially partitioning securities into size-based segments, size-style-based segments within each size-based segment, and size-style-sustainability-based segments within each size-style-based segment based on thresholds; calibrating the thresholds using a simulation-based calibration engine configured to optimize alignment between holdings-based sustainability measures and return-based factor exposures; constructing sustainability indices for each size-style-sustainability segment; and computing sustainability spread factors based on differences between sustainability indices.

In an embodiment, the hierarchical data segmentation is dependency-aware such that segmentation at each stage is conditioned on the output of a preceding stage.

In an embodiment, the sustainability data comprises environmental, social, and governance (ESG) data and overall ESG scores normalized to percentile distributions.

In an embodiment, the simulation-based calibration engine executes Monte Carlo simulations over a plurality of synthetic portfolios.

In an embodiment, the calibrated thresholds maximize a correlation metric between holdings-based sustainability scores and return-based sustainability exposures.

In an embodiment, constructing sustainability indices comprises computing market-capitalization-weighted returns for each segment.

In an embodiment, the method further includes updating the calibrated thresholds periodically in response to changes in underlying dataset characteristics.

In an embodiment, the method further includes estimating time-varying sustainability factor exposures using a statistical estimation technique comprising window regression, Kalman filter or Bayesian estimation.

In an embodiment, the method further includes generating a return-based sustainability score using statistical confidence measures derived from factor exposures.

In an embodiment, the heterogeneous datasets comprise daily price data, monthly sustainability data, and periodic fundamental data.

In an embodiment, the size-style-sustainability-based segments include high-sustainability and low-sustainability groups.

In an embodiment, the method further includes storing the sustainability indices and spread factors in a version-controlled data repository.

In an embodiment, the method further includes generating machine-readable reports via an application programming interface (API).

In an embodiment, the method further includes projecting sustainability exposure data into a two-dimensional visualization for drift detection.

In an embodiment, the hierarchical data segmentation reduces correlation leakage between size, style, and sustainability dimensions.

In an embodiment, the method further includes assigning sustainability alignment categories based on return-based sustainability scores.

In addition, the present disclosure relates to a computer system comprising one or more processors and non-transitory memory storing instructions that, when executed by the processors, cause the system to perform the following operations: ingesting multi-source datasets comprising security price data, corporate fundamental data, and sustainability data; normalizing and synchronizing the datasets into a time-aligned data structure; performing automated hierarchical data segmentation by sequentially partitioning securities into size-based segments, style-based segments within each size-based segment, and sustainability-based segments within each size-style segment using calibrated thresholds; calibrating the thresholds using a simulation-based calibration engine configured to optimize alignment between holdings-based sustainability measures and return-based factor exposures; constructing sustainability indices for each size-style-sustainability segment; and computing sustainability spread factors based on differences between sustainability indices.

In an embodiment, the computer system further comprising a data ingestion engine configured to retrieve heterogeneous datasets from multiple external sources.

In an embodiment, the computer system further comprising a hierarchical data segmentation engine configured to sequentially partition securities across size, style, and sustainability dimensions.

In an embodiment, the computer system further comprising a simulation-based calibration engine configured to execute Monte Carlo simulations in parallel.

In an embodiment, the computer system further comprising an index construction engine configured to dynamically generate sustainability indices.

In an embodiment, the computer system further comprising a factor exposure estimation engine configured to compute return-based sustainability metrics.

In an embodiment, the computer system further comprising a projection engine configured to map multi-dimensional factor exposure vectors into a two-dimensional sustainability scoring map.

In an embodiment, the projection engine applies a deterministic projection function or dimensionality-reduction algorithm.

In an embodiment, the computer system further comprising an anomaly detection engine configured to identify sustainability exposure drift.

In addition, the present disclosure relates to a non-transitory computer-readable medium storing instructions that, when executed by one or more processors, cause the processors to perform operations comprising: ingesting the heterogeneous financial datasets comprising security price data, corporate fundamental data, and sustainability data; normalizing and synchronizing the datasets into a time-aligned data structure; performing automated hierarchical data segmentation on the time-aligned data structure by sequentially partitioning securities into size-based segments, size-style-based segments within each size-based segment, and size-style-sustainability-based segments within each size-style-based segment based on thresholds; calibrating the thresholds using a simulation-based calibration engine configured to optimize alignment between holdings-based sustainability measures and return-based factor exposures; constructing sustainability indices for each size-style-sustainability segment; and computing sustainability spread factors based on differences between sustainability indices.

In an embodiment, the instructions cause the processors to perform automated hierarchical data segmentation using simulation-calibrated thresholds.

In an embodiment, the instructions cause the processors to generate sustainability spread factors.

### BRIEF DESCRIPTION OF THE DRAWINGS

FIG. 1 illustrates an example system architecture for simulation-calibrated sustainability index construction and return-based sustainability analysis according to a non-limiting exemplary embodiment.

FIG. 2 illustrates an example flowchart for data synchronization, identifier resolution, and normalization according to a non-limiting exemplary embodiment.

FIG. 3 illustrates an example pipeline for hierarchical data segmentation according to a non-limiting exemplary embodiment.

FIG. 4 illustrates an example flowchart 160 for simulation-based threshold calibration according to a non-limiting exemplary embodiment.

FIG. 5 illustrates an example plot of synthetic data mapped to ESG scores according to a non-limiting exemplary embodiment.

FIG. 6 illustrates an example flowchart for sustainability index construction according to a non-limiting exemplary embodiment.

FIG. 7 illustrates an example flowchart for factor exposure estimation according to a non-limiting exemplary embodiment.

FIG. 8 illustrates an example plot of ESG factor exposures according to a non-limiting exemplary embodiment.

FIG. 9 illustrates an example plot of t-statistics according to a non-limiting exemplary embodiment.

FIG. 10 illustrates an example flowchart for visualizing ESG scores according to a non-limiting exemplary embodiment.

FIG. 11 illustrates an example two-dimensional sustainability exposure chart generated from multi-dimensional factor exposure vectors according to a non-limiting exemplary embodiment.

FIG. 12 illustrates an example two-dimensional sustainability scoring map generated from multi-dimensional factor exposure vectors according to a non-limiting exemplary embodiment.

FIG. 13 illustrates an example flowchart for data quality, anomaly, and drift detection according to a non-limiting exemplary embodiment.

### DETAILED DESCRIPTION

The present disclosure may be further understood with reference to the following description and the appended drawings, wherein like elements are referred to with the same reference numerals. The present disclosure relates to computer-implemented systems and methods for processing large-scale financial datasets relevant to environmental, social and governance (ESG) frameworks. The exemplary systems and methods support simulation-calibrated ESG index construction and return-based sustainability analysis. In various embodiments, the exemplary system performs automated hierarchical data segmentation, simulation-based threshold calibration, dynamic index construction, and factor-exposure estimation using integrated datasets.

In an embodiment, the systems and methods are implemented within a distributed computing environment comprising one or more processors, non-transitory memory, and networked data interfaces. Program instructions stored in memory configure the processors to execute a plurality of interoperable engines for data ingestion, normalization, hierarchical segmentation, simulation-based calibration, index construction, factor exposure estimation, and sustainability visualization.

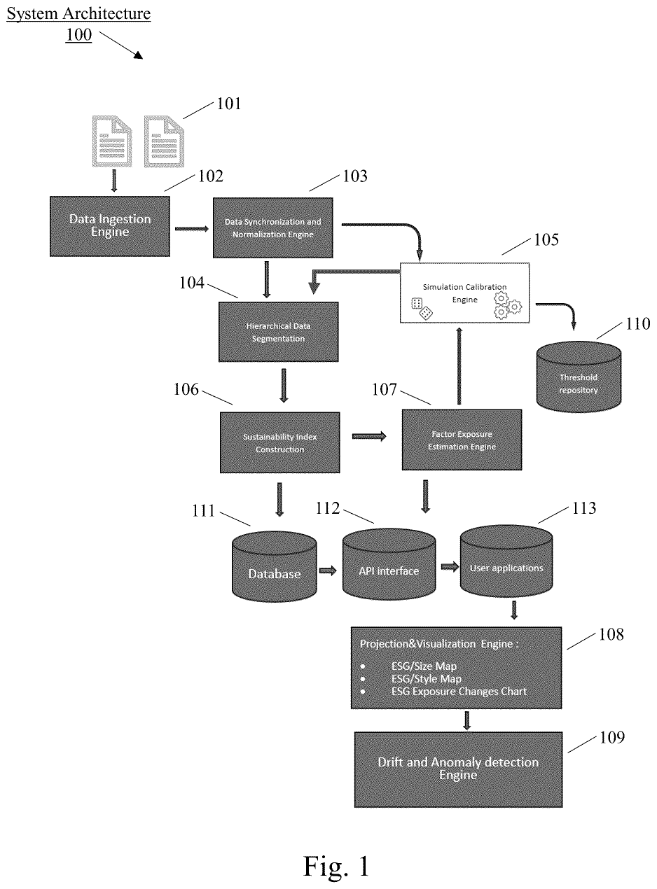

FIG. 1 illustrates an example system architecture 100 for simulation-calibrated sustainability index construction and return-based sustainability analysis according to a non-limiting exemplary embodiment. As shown in FIG. 1, the system architecture 100 comprises interoperable modules including a data ingestion engine 102, a data synchronization and normalization engine 103, a hierarchical data segmentation engine 104, a simulation-based calibration engine 105, a sustainability index construction engine 106, a factor exposure estimation engine 107, a projection and visualization engine 108, and a drift and anomaly detection engine 109 operating within a computer-implemented environment.

The data ingestion engine 102 retrieves heterogeneous datasets 101 relevant to ESG analysis from external sources. As used herein, the term “financial and ESG data” refers to heterogeneous datasets originating from multiple sources with differing schemas, frequencies, and update cycles, including price, fundamental, and ESG data. In an embodiment, the datasets 101 include security price feeds, corporate fundamental databases, and ESG data providers. In an embodiment, the data ingestion engine 102 passes the datasets 101 to the normalization and synchronization engine 103.

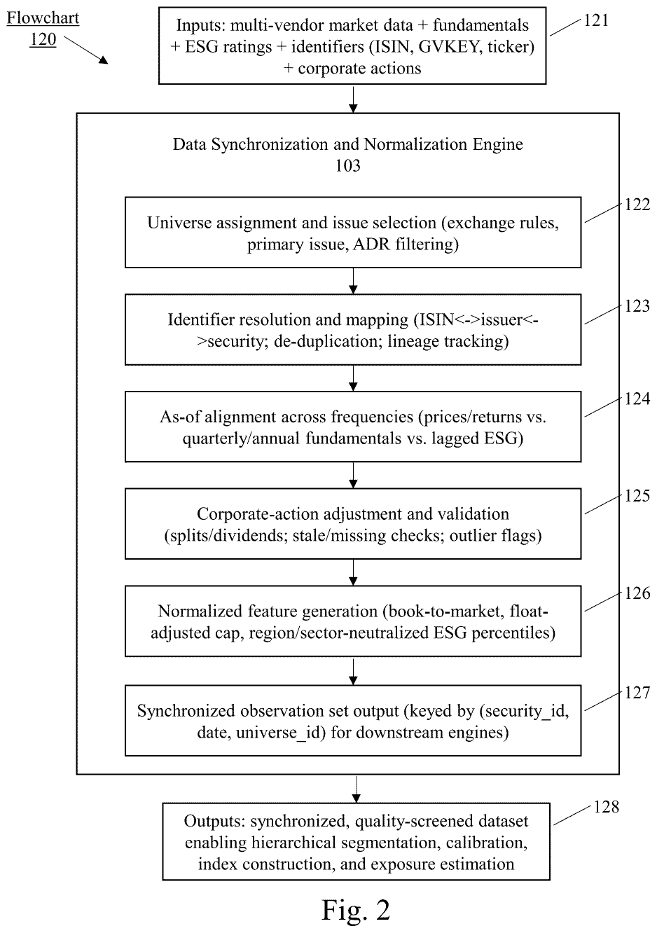

The data synchronization and normalization engine 103 performs initial pre-processing steps on the datasets 101 including, e.g., schema validation, identifier harmonization, corporate-action adjustments, and time-stamping. In an embodiment, the data synchronization and normalization engine 103 aligns datasets with differing update frequencies by applying deterministic temporal alignment rules. In an embodiment, the temporal alignment rules include forward-filling, back-filling, and nearest-available value selection. Sustainability metrics are normalized into percentile-based distributions to ensure comparability across time periods and market regions, as described in greater detail below with regard to FIG. 2. In an embodiment, the data synchronization and normalization engine 103 passes output data to one or more downstream engines including the hierarchical data segmentation engine 104 and/or the simulation calibration engine 105.

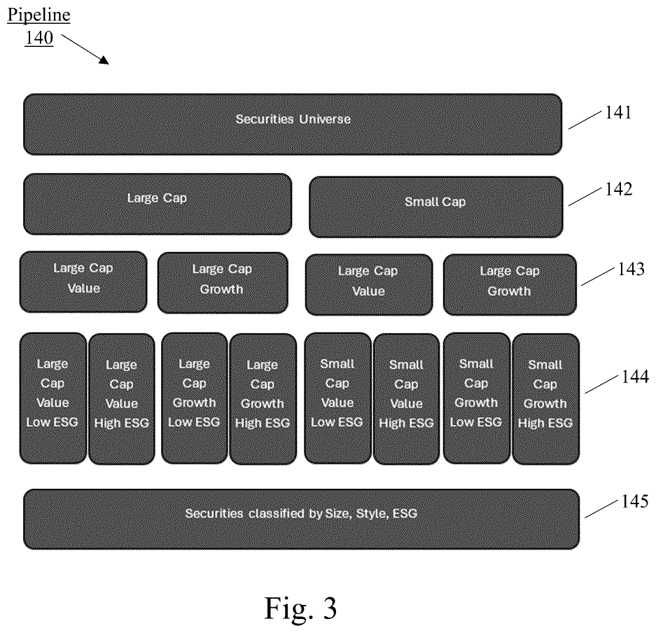

The hierarchical data segmentation engine 104 partitions securities using a sequential, dependency-aware processing pipeline. As used herein, the term “hierarchical data segmentation” refers to a computer-executed process in which data elements are partitioned through multiple ordered stages, wherein segmentation at each stage is conditioned on the output of a preceding stage. The hierarchical data segmentation engine 104 receives as input data the output of the data synchronization and normalization engine 103 and the simulation-based calibration engine 105 as described below. In an embodiment, securities are first segmented into size-based groups using market-capitalization thresholds; within each size-based group, securities are further segmented into style-based groups based on valuation-related attributes; and within each size-style group, securities are segmented into sustainability-based groups using calibrated sustainability thresholds, as described in greater detail below with regard to FIG. 3. The breakpoints between the different groups may be calibrated based on the simulation-based calibration engine 105. In an embodiment, the hierarchical data segmentation engine 104 passes output data to the sustainability index construction engine 106 and/or one or more additional downstream engines.

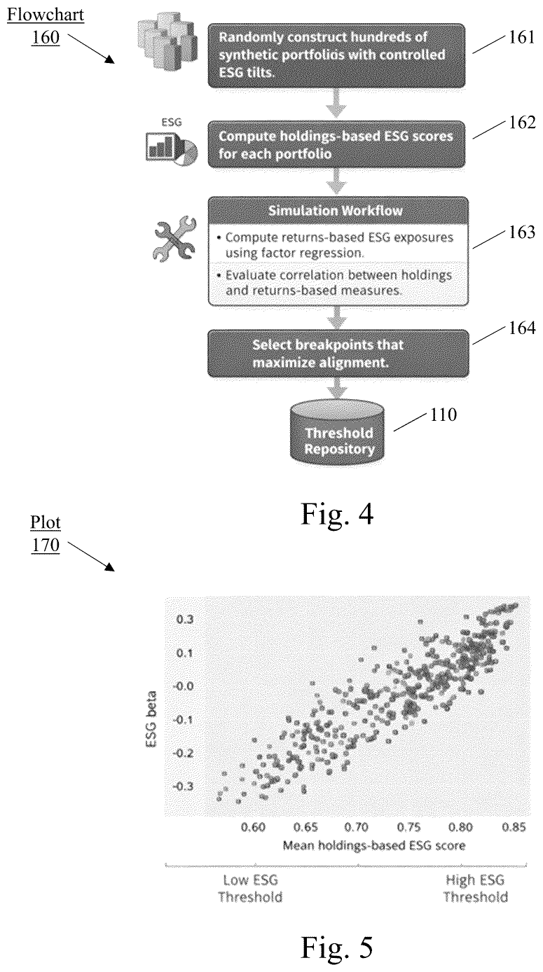

The simulation-based calibration engine 105 calibrates thresholds applied during hierarchical segmentation. As used herein, the term “simulation-based threshold calibration” refers to a computational process that executes a plurality of simulated scenarios to determine threshold values that optimize an objective metric. In an embodiment, the simulation-based calibration engine 105 receives, as input, output data generated by the data synchronization and normalization engine 103, the output data including returns data, fundamentals data, and ESG-related values. The simulation-based calibration engine 105 is configured to generate one or more synthetic portfolios, each synthetic portfolio comprising a randomly selected set of securities having a portfolio size selected in accordance with one or more portfolio-size parameters and having an ESG tilt selected in accordance with one or more ESG-tilt parameters, such that each synthetic portfolio is associated with corresponding returns and ESG scores. In an embodiment, the simulation-based calibration engine 105 executes Monte Carlo simulations over a plurality of the synthetic portfolios to evaluate candidate threshold configurations. Threshold values are then selected based on the Monte Carlo simulations to optimize alignment between holdings-based sustainability characteristics and return-based sustainability factor exposures, as described in greater detail below with respect to FIGS. 4-5. In an embodiment, the simulation-based calibration engine 105 passes output data to the hierarchical data segmentation engine 104. In an embodiment, the simulation-based calibration engine 105 stores calibrated thresholds to a threshold repository 110.

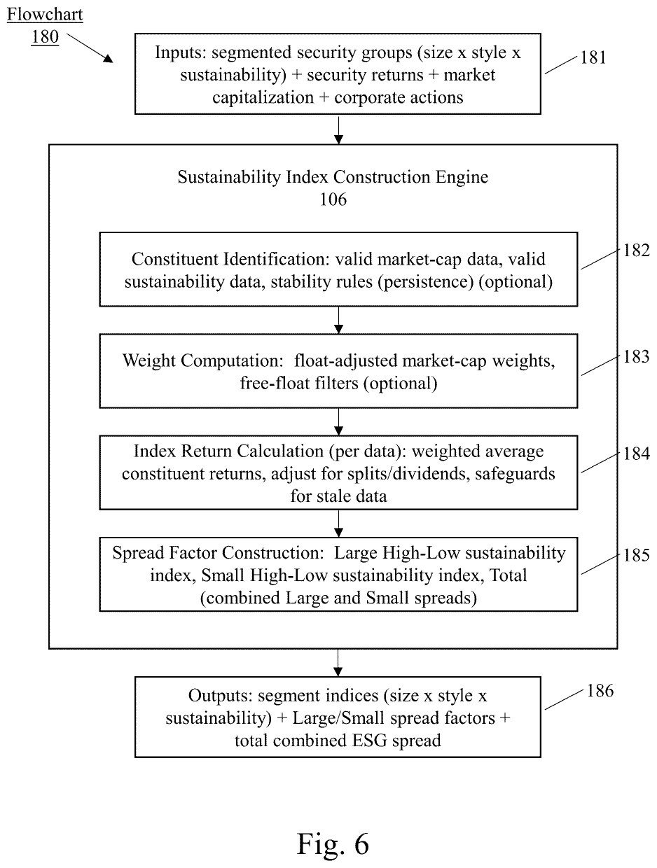

The sustainability index construction engine 106 constructs sustainability indices corresponding to each size-style-sustainability segment. As used herein, the term “sustainability index” refers to a machine-generated time series constructed from segmented securities using algorithmic aggregation rules and the term “sustainability spread factor” refers to a computed difference between two sustainability indices representing different sustainability segments. The sustainability index construction engine 106 receives as input data the output of the hierarchical data segmentation engine 104 and/or one or more additional upstream engines. In an embodiment, sustainability index values are computed using market-capitalization-weighted aggregation and are dynamically updated to reflect changes in underlying segmentation and constituent data, as described in greater detail below with regard to FIG. 6. In an embodiment, the sustainability index construction engine 106 passes output data to the factor exposure estimation engine 107 and/or one or more additional downstream engines.

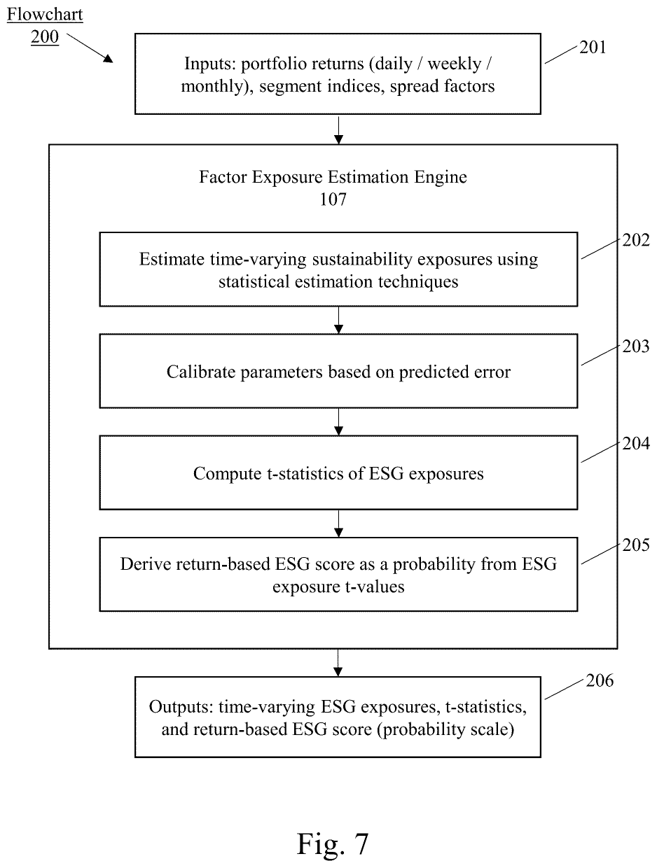

The factor exposure estimation engine 107 computes time-varying sustainability exposures for investment products by analyzing return sensitivity to sustainability indices and sustainability spread factors. As used herein, the term “return-based sustainability analysis” refers to a computer-implemented process for estimating sustainability exposures using statistical relationships between portfolio returns and sustainability indices. The factor exposure estimation engine 107 receives as input data the output of the sustainability index construction engine 106 and/or one or more additional upstream engines. In an embodiment, estimation techniques may include rolling-window regression, Kalman filtering, and regularized estimation. Factor exposure estimation is performed by analyzing return sensitivity of investment products to sustainability indices and sustainability spread factors using statistical estimation techniques, as described in greater detail below with regard to FIGS. 7-9. In an embodiment, the factor exposure estimation engine 107 passes output data to one or more downstream engines including the projection and visualization engine 108.

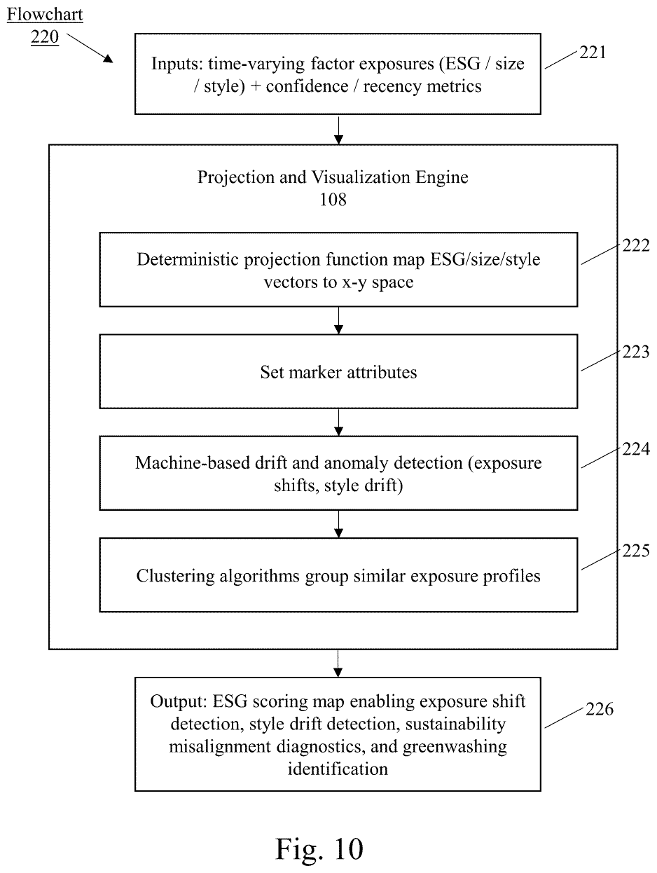

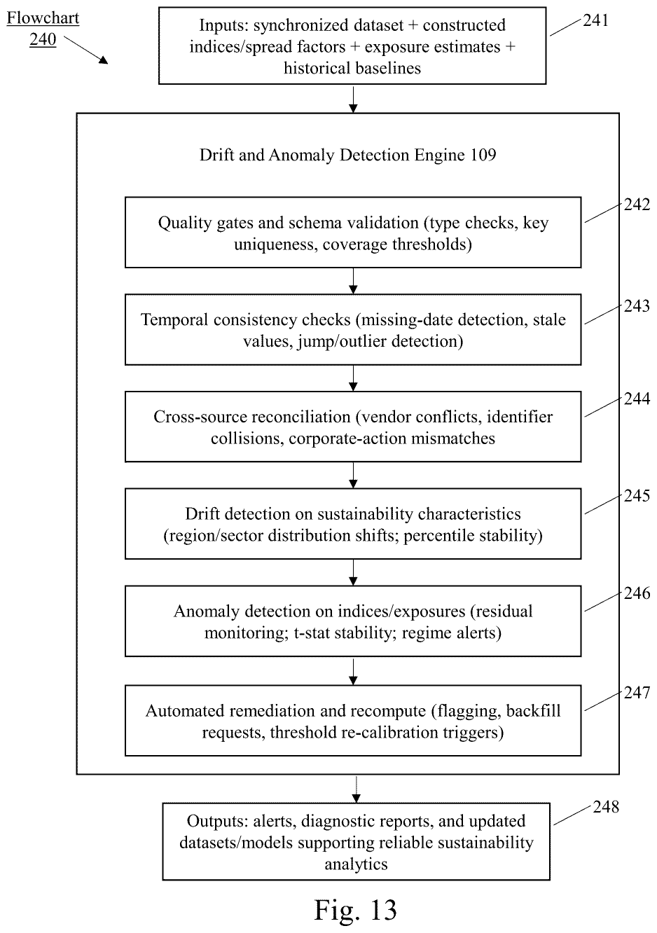

The projection and visualization engine 108 transforms high-dimensional factor exposure data into two-dimensional sustainability scoring maps, as described in greater detail below with regard to FIGS. 10-12. The drift and anomaly detection engine 109 facilitates automated drift detection, clustering, and anomaly identification, as described in greater detail below with regard to FIG. 13. In an embodiment, the functionalities described for the projection and visualization engine 108 and the drift and anomaly detection engine 109 are included in a single engine.

Outputs of the aforementioned engines/modules may be stored in database 111. The database 111 comprises a structured, version-controlled data repository from which the outputs may be exposed to user applications 113 via application programming interfaces 112 (API). For example, the database 111 may store machine-readable reports including, e.g., generated indices, factor exposures, sustainability scores, and alerts, which may be exposed via APIs 112 to enable integration with compliance, reporting, and risk management systems.

In an embodiment, the system may cause a graphical user interface (GUI) to be provided to a display of a user device (e.g., via user applications 113). The GUI may include diagrams, charts, maps, and other features for visualizing the return-based sustainability analysis as described in detail below.

The disclosed computer-implemented system and method provide multiple technical advantages over conventional financial analytics and sustainability assessment systems. These advantages arise from the specific architecture, data-processing pipelines, and simulation-based calibration mechanisms described herein. These technical advantages will be discussed in detail in association with the following Figures.

As used herein, unless the context indicates otherwise, the following notation may be employed to describe example embodiments. This notation is provided for clarity and does not limit the scope of the present disclosure.

With regard to indices and sets, as described in greater detail below with regard to FIG. 2, let t denote a time index (e.g., trading date), i denote a security identifier, and U_t denote an eligible universe of securities at time t after data-quality screening.

With regard to segmentation labels, as described in greater detail below with regard to FIG. 3, let S(i, t) denote a size-segment label for security i at time t, V(i, t) denote a style-segment label within the size segment, and E(i, t) denote a sustainability-segment label within the size-style segment. A composite segment identifier may be denoted by k=(S, V, E).

With regard to returns and capitalization, as described in greater detail below with regard to FIG. 2, let r_{i, t} denote the return of security i over a period ending at t. Let MC_{i, t} denote market capitalization of security i at time t, FF_{i, t} denote a free-float adjustment factor, and FMC_{i, t}=MC_{i, t}*FF_{i, t} denote float-adjusted market capitalization).

With regard to index constituents, as described in greater detail below with regard to FIG. 6, for a segment k at time t, let C_{k, t}={i in U_t: (S(i, t), V(i, t), E(i, t))=k} denote the constituent set. Let w_{i, k, t} denote a constituent weight within segment k at time t.

With regard to ESG spread factor construction, as described in greater detail below with regard to FIG. 6, in an embodiment, segment index returns are aggregated to form size-conditional sustainability spread factors. Let R_{BV, H, t} and R_{BG, H, t} denote, respectively, the Large-Value High-sustainability segment return and the Large-Growth High-sustainability segment return at time t, and let R_{BV, L, t} and R_{BG, L, t} denote the corresponding Low-sustainability returns. In an embodiment, a large-cap sustainability spread may be computed as:

$$B\_esg , t = ( 1 / 2 ) * ( R\_ \{ BV , H , t \} + R\_ \{ BG , H , t \} ) - ( 1 / 2 ) * ( R\_ \{ BV , L , t \} + R\_ \{ BG , L , t \} ) \qquad ( Eq . 1 )$$

In an embodiment, a small-cap sustainability spread may be computed as:

$$S\_esg , t = ( 1 / 2 ) * ( R\_ \{ SV , H , t \} + R\_ \{ SG , H , t \} ) - ( 1 / 2 ) * ( R\_ \{ SV , L , t \} + R\_ \{ SG , L , t \} ) \qquad ( Eq . 2 )$$

In an embodiment, a combined sustainability spread factor is computed as:

$$ESG\_t = ( 1 / 2 ) * ( S\_esg , t + B\_esg , t ) \qquad ( Eq . 3 )$$

With regard to factor-vector notation and regression modeling, as described in greater detail below with regard to FIGS. 6-7, in an embodiment, a factor vector is defined as F_t=[MKT_t, SMB_t, HML_t, ESG_t]\hat{ }T, where MKT_t denotes a market excess return, SMB_t denotes a size factor return, HML_t denotes a value factor return, and ESG_t denotes the sustainability spread factor of Eq. 3. For an investment product or portfolio p, where beta_p=[beta_{p, MKT}, beta_{p, SMB}, beta_{p, HML}, beta_{p, ESG}]\hat{ }T denotes estimated factor sensitivities, an excess return series r_{p, t} may be modeled as:

$$r\_ \{ p , t \} = alpha\_p + beta\_p \hat{} T * F\_t + epsilon\_ \{ p , t \} \qquad ( Eq . 4 )$$

With regard to holdings-based sustainability scoring, as described in greater detail below with regard to FIG. 7, in an embodiment, a holdings-based sustainability score is computed as a market-value-weighted average of constituent issuer scores. For portfolio p holding m securities at time t with weights w_{i, t} satisfying sum_{i=1 . . . m}w_{i, t}=1, a holdings-based score may be computed as:

$$p\_t \hat{} ( h ) = sum\_ \{ i = 1 … m \} w\_ \{ i , t \} * ESG\_ \{ i , t \} \qquad ( Eq . 5 )$$

When comparing to regression estimates computed over a window T, the holdings-based score may be averaged over the same window as:

$$pbar\_T \hat{} ( h ) = ( 1 / \vert T \vert ) * sum\_ \{ t in T \} p\_t \hat{} ( h ) \qquad ( Eq . 6 )$$

With regard to returns-based sustainability scoring and confidence, as described in greater detail below with regard to FIG. 7, in an embodiment, a returns-based sustainability score is derived from the estimated sustainability loading beta_{p, ESG} and its associated uncertainty. Let se(beta_hat_{p, ESG}) denote a standard error of an estimated loading. A t-statistic may be computed as:

$$t\_ \{ p , ESG \} = beta\_hat \_ \{ p , ESG \} / se ( beta\_hat \_ \{ p , ESG \} ) \qquad ( Eq . 7 )$$

In an embodiment, the t-statistic is converted into a probabilistic score using a Student-t cumulative distribution function (CDF) with degrees of freedom nu=|T|−k−1 (k being the number of factors):

$$p\_p \hat{} ( r ) = CDF\_t ( t\_ \{ p , ESG \} ; nu ) \qquad ( Eq . 8 )$$

Other monotone mappings from (beta_hat_{p, ESG}, se(beta_hat_{p, ESG})) to a score may be used.

With regard to Monte Carlo breakpoint calibration notation, as described in greater detail below with regard to FIG. 4, in an embodiment, candidate breakpoint configurations are evaluated via Monte Carlo portfolio simulations with controlled sustainability tilts. Let s_{j, t} denote an issuer-level sustainability score for issuer j at month t within a calibration window of length T. A time-averaged issuer score may be computed as:

$$sbar\_j = ( 1 / T ) * sum\_ \{ t = 1 … T \} s\_ \{ j , t \} , sbar\_j < - max ( sbar\_j , 10 \hat{} - 6 ) \qquad ( Eq . 9 )$$

For simulation n, a tilt parameter lambda_n may be sampled (e.g., lambda_n~Uniform[−3,3]) and issuer selection probabilities may be computed as:

$$pi\_j \hat{} ( n ) = ( sbar\_j \hat{} ( lambda\_n ) ) / ( sum\_k sbar\_k \hat{} ( lambda\_n ) ) \qquad ( Eq . 10 )$$

A synthetic portfolio is formed by sampling K issuers without replacement according to {pi_j\hat{ }(n)} and computing portfolio returns and holdings-based scores over the window. Across N simulations, an alignment metric may be computed as corr({pbar_n\hat{ }(h)}, {beta_hat_{n, ESG}}) and/or corr({pbar_n\hat{ }(h)}, {p_n\hat{ }(r)}), and a breakpoint configuration may be selected that improves alignment subject to stability constraints.

FIG. 2 illustrates an example flowchart 120 for data synchronization, identifier resolution, and normalization according to a non-limiting exemplary embodiment. In an embodiment, the flowchart 120 corresponds to operations performed by the data synchronization and normalization engine 103 described above in FIG. 1. The flowchart 120 describes operations for integrating heterogeneous datasets across frequencies and vendors.

The data ingestion engine 102 (not shown in FIG. 2) generates input data 121 for the data synchronization and normalization engine 103. As described above with regard to FIG. 1, the data ingestion engine 102 retrieves heterogeneous datasets from external sources, including security price feeds, corporate fundamental databases, and ESG data providers. These data are retrieved with differing schemas, frequencies, and update cycles.

In 122, the data synchronization and normalization engine 103 defines universes and assigns exchanges to the input data 121. In an embodiment, securities are assigned to regional universes using exchange listing and trading-activity rules. A security is included in a United States universe when a majority of the security's trading activity, as measured by trading volume, occurs on United States exchanges. For securities not included in the United States universe, a primary listed issue is selected for downstream processing. In some embodiments, depositary receipts (e.g., American Depositary Receipt (ADR)) are filtered and excluded from universe membership.

With regard to regional universe composition, in an embodiment, a United Kingdom universe comprises securities listed on the London Stock Exchange, a Japan universe comprises securities traded on the Tokyo Stock Exchange, and a Europe ex-UK universe comprises securities listed on exchanges in one or more of Switzerland, Germany, Denmark, Austria, Belgium, Spain, Finland, France, Ireland, Italy, the Netherlands, Portugal, Norway, Poland, and Sweden. For certain downstream index-construction operations, the United Kingdom universe and the Europe ex-UK universe are combined into a consolidated Europe universe.

In 123, the data synchronization and normalization engine 103 performs identifier resolution and mapping. Identifiers may include, e.g., International Securities Identification Number (ISIN), global company key (GVKEY), ticker, etc. In an embodiment, a security is associated with an identifier (e.g., ISIN) and an issuer. In an embodiment, duplicate datasets are removed. In an embodiment, the lineage of a security is tracked.

In 124, the data synchronization and normalization engine 103 aligns returns, corporate actions, and market capitalization. In an embodiment, periodic security returns are computed from end-of-period prices obtained from the relevant exchange. In an embodiment, the synchronization includes sustainability data integration and lagging. In an embodiment, sustainability data (e.g., ESG) comprises an overall sustainability percentile score and pillar scores for environmental, social, and governance dimensions. Identifier mappings (e.g., ISIN) are used to link company-level sustainability records to security-level returns and fundamentals. When sustainability scores are published with a reporting delay, the system applies a fixed lag (e.g., six months) before using the sustainability values in segmentation, calibration, factor construction, or index construction.

In 125, the data synchronization and normalization engine 103 adjusts for corporate actions including splits and dividends and validates the dataset by applying data quality safeguards. In an embodiment, market capitalization is computed as shares outstanding multiplied by the corresponding end-of-period price, optionally adjusted by a free-float factor when available. The system may apply data-quality safeguards by detecting missing values, stale values, coverage gaps, or identifier conflicts and by excluding or flagging records that fail validation rules.

In 126, the data synchronization and normalization engine 103 performs fundamental synchronization for book-to-market. In one embodiment, book-to-market ratios are computed using company-level fundamental data including total assets and total liabilities obtained from annual and/or quarterly reports. Because fundamental reporting dates may not coincide with return and market-cap observation dates, the system synchronizes fundamentals to a market-cap observation date t using an as-of alignment rule. For example, for each security i and date t, the system selects the closest available fundamental values within a defined lookback window (e.g., the most recent values on or prior to t) and computes book-to-market using the aligned values and the market capitalization observed at t.

In an embodiment, the data synchronization and normalization engine 103 generates normalized features including region-and sector-neutralized sustainability percentiles. In an embodiment, to reduce systematic drift across regions and industry sectors, the system transforms raw sustainability measures into region- and sector-conditioned percentiles. For example, for each region-sector group g at time t, the system computes a percentile score p_{i, t}\hat{ }{(g)} from the cross-sectional rank of the sustainability measure within g. The neutralized percentiles may be computed for the overall sustainability score and for each pillar score, thereby reducing spurious variation attributable to sector composition changes or region-level coverage effects.

In 127, the data synchronization and normalization engine 103 generates a synchronized observation set to pass to downstream engines. In an embodiment, the synchronized observation set is keyed by a security identifier, a date, and a universe identifier.

The output 128 of the data synchronization and normalization engine 103 comprises a synchronized, quality-screened dataset. The output 128 of the data synchronization and normalization engine 103 enables hierarchical segmentation, calibration, index construction, and exposure estimation.

The data synchronization and normalization engine 103 facilitates technical advantages including enabling scalable processing of heterogeneous financial and sustainability datasets. The integration of data ingestion, normalization, and synchronization allows the system to process large volumes of price, fundamental, and ESG data with differing update frequencies. This architecture supports high-throughput execution in distributed computing environments without manual intervention.

FIG. 3 illustrates an example pipeline 140 for hierarchical data segmentation according to a non-limiting exemplary embodiment. In an embodiment, the pipeline 140 corresponds to operations performed by the hierarchical data segmentation engine 104 described above in FIG. 1. In an embodiment, the input to the pipeline 140 comprises a securities universe 141 determined by the data synchronization and normalization engine 103.

The pipeline 140 comprises a size-based segmentation stage 142, a style-based segmentation stage 143, and a sustainability-based segmentation stage 144. As illustrated in FIG. 3, the hierarchical data segmentation pipeline 140 executes a sequential, dependency-aware partitioning process in which securities are first segmented by size, then by style within each size segment, and finally by sustainability within each size-style segment.

In an exemplary embodiment, a breakpoint is computed in the size-based segmentation stage 142 as follows. In one embodiment, a size breakpoint at quantile q is computed as b_size(t, q)=Q_q({MC_{i, t}: i in U_t}). A security is assigned to a size segment (e.g., large cap, mid cap, small cap) by comparing MC_{i, t} to one or more such breakpoints. In an exemplary embodiment, size labels are assigned first to define size-conditioned subsets.

In an exemplary embodiment, style labels are computed in the style-based segmentation stage 143 as follows. In an embodiment, the style labels (e.g., value, growth) are computed within each size subset using a style attribute (e.g., BM_{i, t}) and style breakpoints b_style(t, q|S).

In an exemplary embodiment, sustainability labels are then computed in the sustainability-based segmentation stage 144 as follows. In an exemplary embodiment, the sustainability labels are computed within each size-style subset using sustainability breakpoints b_esg(t, q|S, V).

In an embodiment, the output of the pipeline 140 comprises securities 145 sorted into twelve buckets defined by size, style, and ESG thresholds.

The hierarchical data segmentation pipeline 140 as performed by the hierarchical data segmentation engine 104 facilitates technical advantages including improved computational accuracy. By performing segmentation in ordered, dependency-aware stages, the system reduces correlation leakage between segmentation dimensions such as size, style, and sustainability. This technical improvement enables more stable and reproducible index construction and factor exposure estimation compared to systems that rely on independent or static partitioning techniques.

FIG. 4 illustrates an example flowchart 160 for simulation-based threshold calibration according to a non-limiting exemplary embodiment. In an embodiment, the flowchart 160 corresponds to operations performed by the simulation-based calibration engine 105 described above in FIG. 1. In an embodiment, the input to the flowchart 160 comprises a securities universe 141 determined by the data synchronization and normalization engine 103 and synthetic portfolio data. The calibration may be executed using Monte Carlo portfolio simulations.

In 161, the simulation-based calibration engine 105 constructs synthetic portfolios with controlled ESG tilts. In an embodiment, for each simulation n=1 . . . N, a synthetic portfolio is formed using selection probabilities pi_j\hat{ }(n) derived from issuer sustainability scores (Eq. 9-Eq. 10). In an embodiment, the simulation-based calibration engine 105 may construct hundreds or more synthetic portfolios.

FIG. 5 illustrates an example plot 170 of synthetic data mapped to ESG scores according to a non-limiting exemplary embodiment.

In 162, the simulation-based calibration engine 105 computes a holdings-based sustainability score over a calibration window as pbar_n\hat{ }(h) (Eq. 6).

In 163, the simulation-based calibration engine 105 computes returns-based ESG exposures using factor regression and evaluates correlation between holdings and returns-based measures. In an embodiment, for a candidate breakpoint configuration theta (e.g., a pair of sustainability percentile breakpoints (delta_L, delta_H) applied within each size-style segment), factor time series including ESG_t (Eq. 3) are computed and regression-based sustainability loadings beta_hat_{n, ESG} are estimated for each synthetic portfolio using the factor model of Eq. 4.

In 164, the simulation-based calibration engine 105 selects breakpoints that maximize alignment. In an embodiment, an alignment metric may be computed as A(theta)=corr({pbar_n\hat{ }(h)}, {beta_hat_{n, ESG}}) and/or corr({pbar_n\hat{ }(h)}, {p_n\hat{ }(r)}), where p_n\hat{ }(r) is a returns-based score derived from t-statistics (Eq. 7-Eq. 8). In an embodiment, the simulation engine searches over candidate breakpoint configurations, enforces ordering and stability constraints.

The simulation-based calibration engine 105 stores an optimal configuration theta* in the threshold repository 110.

The simulation-based calibration engine 105 facilitates technical advantages including a data-driven mechanism for selecting segmentation parameters. Unlike heuristic or manually configured thresholds, the disclosed simulation engine 105 evaluates candidate configurations using Monte Carlo portfolio simulations and objective alignment metrics. This approach improves robustness to noise, adapts dynamically to changing data characteristics, and enhances the reliability of downstream analytics. Thresholds may be recalibrated on an annual basis after index reconstitution.

FIG. 6 illustrates an example flowchart 180 for sustainability index construction according to a non-limiting exemplary embodiment. In an embodiment, the flowchart 180 corresponds to operations performed by the sustainability index construction engine 106 described above in FIG. 1. The inputs 181 to the sustainability index construction engine 106 comprise segmented security groups, security returns, market capitalization, and corporate actions.

In 182, the sustainability index construction engine 106 identifies constituents of the segmented security groups. The constituents are identified based on valid market-cap data, valid sustainability data, and stability rules (persistence) (optional).

In 183, the sustainability index construction engine 106 computes weights. In an embodiment, float-adjusted market-cap weights are computed as w_{i, k, t}=FMC_{i, t}/sum_{j in C_{k, t}} FMC_{j, t}.

In 184, the engine calculates index return as weighted average constituent returns, adjusted for splits/dividends and safeguarded for stale data. In an embodiment, a segment index return is computed as R_{k, t}=sum_{i in C_{k, t}} w_{i, k, t}*r_{i, t}, after applying corporate-action adjustments and stale-data safeguards.

In 185, the sustainability index construction engine 106 constructs spread factors. In an embodiment, the system computes size-conditional sustainability spread factors B_esg, t and S_esg, t and a combined sustainability spread factor ESG_t according to Eq. 1-Eq. 3, using segment index returns derived from the hierarchical segmentation outputs.

The output 186 of the sustainability index construction engine 106 comprises segment indices, Large/Small ESG spread factors and total combined ESG spread.

The sustainability index construction engine 106 facilitates technical advantages including a consistent computational foundation for return-based sustainability analysis. By generating machine-defined indices directly from segmented datasets, the system avoids reliance on externally defined benchmarks and ensures reproducibility of analytical results across time periods and market regions.

FIG. 7 illustrates an example flowchart 200 for factor exposure estimation according to a non-limiting exemplary embodiment. In an embodiment, the flowchart 200 corresponds to operations performed by the factor exposure estimation engine 107 described above in FIG. 1. The flowchart 200 is for computing return-based sustainability metrics. The inputs 201 to the factor exposure estimation engine 107 comprise portfolio returns, segment indices, and spread factors. Factor exposure estimation is performed by analyzing return sensitivity of investment products to sustainability indices and sustainability spread factors using statistical estimation techniques.

In 202, the factor exposure estimation engine 107 estimates time-varying sustainability exposures using statistical estimation techniques including, e.g., rolling-window regression, Kalman filtering, and regularized estimation. In an embodiment, for an investment product p, an excess return series r_{p, t} is modeled as r_{p, t}=alpha_p+beta_p\hat{ }T*F_t+epsilon_{p, t} (Eq. 4), where F_t includes market, size, value, and sustainability spread factors and beta_{p, ESG} captures conditional sustainability sensitivity.

In 203, the factor exposure estimation engine 107 calibrates parameters based on predicted error. In an embodiment, at operation 203, the factor exposure estimation engine 107 is configured to calibrate one or more model parameters based on an out-of-sample (OOS) prediction error. As used herein, “model parameters” include, by way of non-limiting examples, a rolling-window length, a decay or weighting parameter for locally weighted regression, and state-evolution and measurement-noise parameters for a Kalman filter. In embodiments employing Bayesian estimation, the model parameters further include prior distribution parameters and/or hyperparameters. The factor exposure estimation engine 107 is configured to generate time-varying exposure estimates using one or more statistical estimation models, wherein the exposure estimates depend on the model parameters. The factor exposure estimation engine 107 is further configured to tune, for each candidate estimation model, the model parameters by evaluating out-of-sample (OOS) prediction error on a validation period and selecting parameter values that reduce the OOS prediction error, thereby improving predictive stability of the exposure estimates.

In 204, the factor exposure estimation engine 107 computes confidence metrics (e.g., t-statistics) of ESG exposures. In an embodiment, a standard error se(beta_hat_{p, ESG}) is computed for an estimated sustainability loading and a t-statistic t_{p, ESG} is computed as in Eq. 7. The system may store t-statistics, confidence intervals, and window metadata for downstream scoring and monitoring.

In 205, the factor exposure estimation engine 107 maps sustainability scores. In an embodiment, a return-based sustainability score p_p\hat{ }(r) is computed by mapping the t-statistic t_{p, ESG} to a probability via a Student-t CDF (Eq. 8), thereby producing a normalized score suitable for comparison across products and time windows.

The output 206 of the factor exposure estimation engine 107 is time-varying ESG exposures, t-statistics, and return-based ESG score (probability scale).

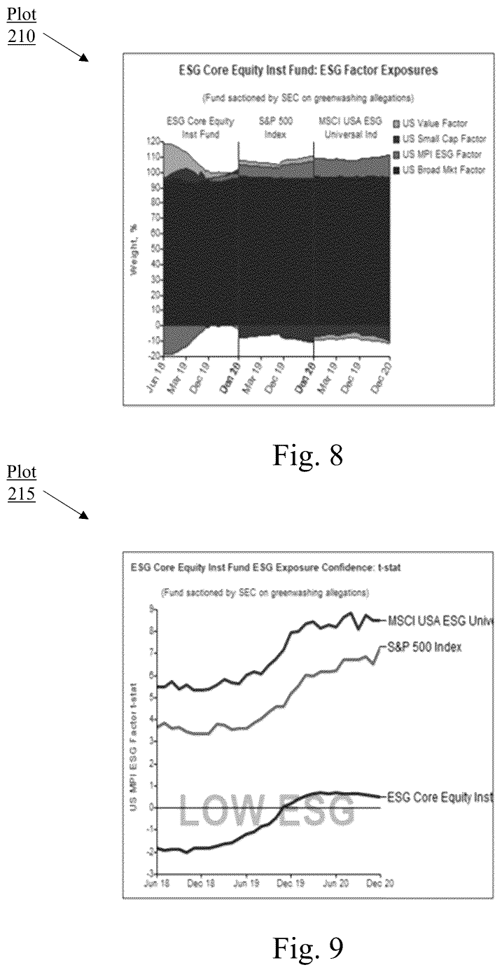

FIG. 8 illustrates an example plot 210 of ESG factor exposures according to a non-limiting exemplary embodiment. In an embodiment, FIG. 8 illustrates an example graphical output generated by the projection and visualization engine (e.g., engine 108) based on factor exposures estimated by the factor exposure estimation engine (e.g., engine 107). The plot 210 depicts a time series, stacked-area representation of estimated factor exposure weights (y-axis, in percent) for one or more investment products over a sequence of time intervals (x-axis).

As shown, the stacked regions correspond to a plurality of factors, including, by way of non-limiting example: (i) a broad market factor, (ii) a size factor (e.g., small-cap), (iii) a value factor, and (iv) an ESG (sustainability) factor. For each time interval, the relative area (or height) of each region indicates the magnitude and sign of the corresponding estimated exposure weight, thereby providing a visual decomposition of an investment product's return behavior into contributions attributable to the respective factors.

In the illustrated example, the plot 210 further includes a comparative view across multiple investment products (e.g., a fund and one or more benchmark indices), separated into distinct panels or segments, enabling side-by-side comparison of the factor exposure profiles. In an embodiment, such visualization is used to support monitoring and validation of sustainability-related exposures, including identifying drift in exposures over time and detecting anomalous exposure patterns relative to one or more reference indices or universes. In an embodiment, the graphical output further illustrates a compliance-or validation-oriented use case in which an investment fund self-identifies as an ESG-oriented fund, while the returns-based ESG factor exposure estimated for the fund does not exhibit a corresponding persistent ESG loading. For example, although an ESG-oriented strategy update or re-positioning may be indicated for the fund, the estimated ESG-factor exposure remains weak in magnitude and unstable over an extended sequence of time intervals thereafter. In an embodiment, this mismatch between a stated ESG orientation and the computed returns-based ESG exposure is used to generate a flag, alert, or exception record for further review, such as for monitoring, due diligence, or anti-greenwashing analytics.

FIG. 9 illustrates an example plot 215 of t-statistics according to a non-limiting exemplary embodiment. In an embodiment, FIG. 9 further illustrates a confidence metric associated with the estimated returns-based ESG exposure for an investment product. In particular, the plot 215 depicts a time series of an ESG-factor t-statistic (y-axis) computed for each time interval (x-axis) from the statistical estimation performed by the factor exposure estimation engine (e.g., engine 107). As used herein, the “t-statistic” is a model-derived measure of statistical significance for the ESG-factor loading and may be computed as a ratio of an estimated ESG exposure to a corresponding estimated standard error.

As shown, reference indices (e.g., an ESG-designated benchmark index and a broad-market index) exhibit consistently positive and increasing ESG-factor t-statistics over the illustrated time horizon, indicating comparatively strong and statistically significant ESG exposures. By contrast, the analyzed investment fund, although identified as ESG-oriented, exhibits a low-magnitude ESG-factor t-statistic that remains near zero and/or only briefly rises above a significance threshold, and in some intervals is negative. In an embodiment, this weak and unstable t-statistic profile indicates that the fund's returns-based ESG exposure is not reliably distinguishable from noise for an extended period. In an embodiment, the projection and visualization engine (or a drift/anomaly detection engine) uses the persistently low ESG-factor t-statistic to generate a “low-confidence ESG exposure” condition, which may be stored as an alert or exception record for monitoring, validation, or anti-greenwashing analytics.

The factor exposure estimation engine 107 facilitates technical advantages including detecting gradual shifts, abrupt changes, and anomalous behavior in sustainability exposure. By enabling a dynamic and time-varying sustainability analysis using statistical estimation techniques such as rolling regression and Kalman filtering, the system can identify behavior in sustainability exposure that cannot be identified using static or holdings-only approaches.

FIG. 10 illustrates an example flowchart 220 for visualizing ESG scores according to a non-limiting exemplary embodiment. In an embodiment, the flowchart 220 corresponds to operations performed by the projection and visualization engine 108 described above in FIG. 1. As illustrated in FIGS. 10-12, multi-dimensional sustainability factor exposures are projected into a two-dimensional sustainability scoring map using deterministic projection functions. The scoring map enables automated detection of sustainability drift, anomalous exposure behavior, and deviations from stated sustainability objectives. The inputs 221 to the projection and visualization engine 108 include time-varying factor exposures (ESG/size/style) and confidence/recency metrics.

In 222, the projection and visualization engine 108 maps ESG/size/style vectors to an x-y space using a deterministic projection function. In one embodiment, an exposure vector b_t=(beta_ESG, t, beta_Size, t, beta_Style, t, . . . ) is mapped to two dimensions as (x_t, y_t)=P(b_t) using a deterministic projection function P(.), which may comprise a linear transform, a rotation, or a dimensionality-reduction mapping.

In 223, the projection and visualization engine 108 sets marker attributes. In an embodiment, marker size s_t is set proportional to a recency weight or volatility, e.g., s_t proportional to lambda_t or s_t proportional to sigma_t.

In 224, the projection and visualization engine 108 performs drift and anomaly detection. In an embodiment, a drift event may be flagged when ∥(x_t, y_t)−(x_{t−1}, y_{t−1})∥exceeds a threshold delta.

In 225, the projection and visualization engine 108 groups similar exposure profiles by clustering algorithms.

The output 226 of the projection and visualization engine 108 may comprise an ESG scoring map enabling exposure shift detection, style drift detection, sustainability misalignment diagnostics, and greenwashing identification.

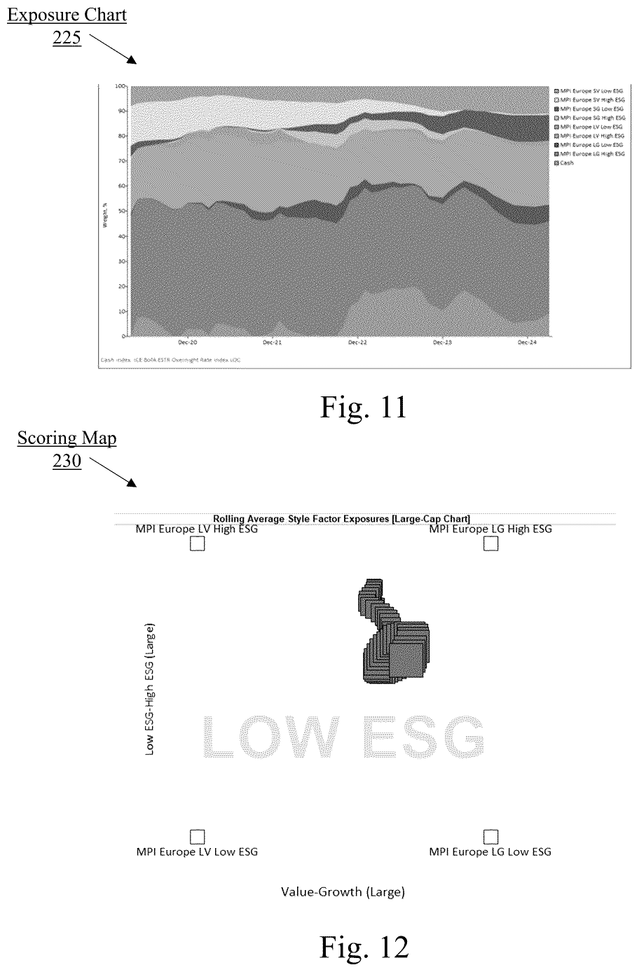

FIG. 11 illustrates an example two-dimensional sustainability exposure chart 225 generated from multi-dimensional factor exposure vectors according to a non-limiting exemplary embodiment. FIG. 11 illustrates an example two-dimensional sustainability exposure chart 225 generated from multi-dimensional factor exposure vectors according to a non-limiting exemplary embodiment. In an embodiment, the chart 225 is generated by the projection and visualization engine (e.g., engine 108) from a set of time-indexed factor exposure vectors output by the factor exposure estimation engine (e.g., engine 107). Each factor exposure vector corresponds to a respective time interval and includes a plurality of exposure values associated with a segmented sustainability index universe (e.g., exposures to indices representing combinations of region, size, style, and sustainability tier).

As shown, the chart 225 provides a two-dimensional representation in which a first dimension corresponds to time (horizontal axis) and a second dimension corresponds to exposure weight (vertical axis). In the illustrated example, the exposure weights are displayed as a stacked area plot in which each stacked band corresponds to a respective segment-level sustainability index (e.g., region-by-size-by-style-by-ESG tier indices) and, optionally, an additional allocation or residual component (e.g., cash or an intercept/residual exposure). The relative thickness of each band at a given time interval represents the magnitude of the corresponding estimated exposure weight for that interval, thereby enabling visual assessment of how an investment product's sustainability-related exposures evolve over time across multiple sustainability segments.

In an embodiment, the chart 225 is used to support monitoring and diagnostics, including identifying (i) drift in exposures across sustainability tiers or style segments, (ii) regime shifts in exposure composition, and/or (iii) anomalous transitions such as abrupt increases or decreases in one or more segment-level exposures relative to historical levels. In an embodiment, the projection and visualization engine stores the displayed exposure time series and/or generates one or more alerts when drift or anomaly conditions are satisfied.

FIG. 12 illustrates an example two-dimensional sustainability scoring map 230 generated by projecting multi-dimensional factor exposure vectors into a two-dimensional coordinate system according to a non-limiting exemplary embodiment. In an embodiment, the sustainability scoring map 230 is generated by the projection and visualization engine (e.g., engine 108) from factor exposures estimated for an investment product by the factor exposure estimation engine (e.g., engine 107), wherein the factor exposures include exposures to a plurality of segment-level indices corresponding to combinations of size, style, and sustainability groupings produced by the hierarchical data segmentation engine (e.g., engine 104) and the sustainability index construction engine (e.g., engine 106). As shown, the map 230 includes a first axis corresponding to a style dimension (e.g., value-to-growth) and a second axis corresponding to a sustainability dimension (e.g., low-ESG to high-ESG), such that a two-dimensional coordinate (x, y) represents a reduced-form representation of the investment product's estimated exposures. In an embodiment, the projection and visualization engine 108 computes the coordinate (x, y) by applying a projection operator to the multi-dimensional exposure vector, including, by way of non-limiting examples, a linear projection, principal-component-based projection, or a constrained mapping that preserves relative distances between exposure profiles.

In the illustrated example, reference locations on the map correspond to segment-level sustainability indices (e.g., “Large Value High ESG,” “Large Value Low ESG,” “Large Growth High ESG,” and “Large Growth Low ESG”), and a plotted marker corresponding to the investment product is positioned based on its projected coordinate. In an embodiment, the marker position is updated for each time interval to form a trajectory over time, thereby enabling visualization of exposure drift between sustainability tiers and/or between style regimes. In an embodiment, the projection and visualization engine 108 uses the map 230 to support monitoring and diagnostics by identifying when the investment product's projected coordinate (i) crosses one or more predetermined boundaries, (ii) deviates beyond a threshold distance from a reference ESG-designated index, and/or (iii) exhibits a rate-of-change exceeding a drift threshold, and, responsive thereto, stores an alert or exception record and/or provides an output to one or more user applications via an API.

The projection and visualization engine 108 facilitates technical advantages including automated drift detection, clustering, and anomaly identification. By providing an efficient mechanism for transforming high-dimensional factor exposure data into a two-dimensional sustainability scoring map, the system improves interpretability while preserving computational rigor.

FIG. 13 illustrates an example flowchart 240 for data quality, anomaly, and drift detection according to a non-limiting exemplary embodiment. In an embodiment, the flowchart 240 corresponds to operations performed by the drift and anomaly detection engine 109 and/or the projection and visualization engine 108 described above in FIG. 1. As shown in FIG. 13, the drift and anomaly detection engine 109 shows operations for monitoring synchronized inputs, constructed indices, and exposure estimates and for triggering remediation or recomputation actions. The inputs 241 to the drift and anomaly detection engine 109 include a synchronized dataset, constructed indices/spread factors, exposure estimates and historical baselines.

In 242, the drift and anomaly detection engine 109 passes the inputs 241 through quality gates and performs schema validation. In an embodiment, the validation includes type checks, key uniqueness, coverage thresholds.

In 243, the drift and anomaly detection engine 109 performs temporal consistency checks. In an embodiment, the checks include missing-date detection, stale values, jump/outlier detection.

In 244, the drift and anomaly detection engine 109 performs cross-source reconciliation. In an embodiment, the projection and visualization engine 108 reconciles vendor conflicts, identifier collisions, corporate-action mismatches.

In 245, the drift and anomaly detection engine 109 performs drift detection on sustainability characteristics. In an embodiment, the drift detection includes region/sector distribution shifts and percentile stability.

In 246, the drift and anomaly detection engine 109 performs anomaly detection on indices/exposures. In an embodiment, the anomaly detection includes residual monitoring, t-stat stability and regime alerts.

In 247, the drift and anomaly detection engine 109 performs automated remediation and recompute. In an embodiment, the remediation and recompute includes flagging, backfill requests, and threshold re-calibration triggers.

The outputs 248 of the drift and anomaly detection engine 109 include alerts, diagnostic reports, and updated datasets/models supporting reliable sustainability analytics.

Accordingly, the disclosed computer-implemented system and method provide multiple technical advantages over conventional financial analytics and sustainability assessment systems.

First, the invention provides improved computational accuracy through automated hierarchical data segmentation. By performing segmentation in ordered, dependency-aware stages, the system reduces correlation leakage between segmentation dimensions such as size, style, and sustainability. This technical improvement enables more stable and reproducible index construction and factor exposure estimation compared to systems that rely on independent or static partitioning techniques.

Second, the use of simulation-based threshold calibration provides a data-driven mechanism for selecting segmentation parameters. Unlike heuristic or manually configured thresholds, the disclosed simulation engine evaluates candidate configurations using Monte Carlo portfolio simulations and objective alignment metrics. This approach improves robustness to noise, adapts dynamically to changing data characteristics, and enhances the reliability of downstream analytics.

Third, the invention enables scalable processing of heterogeneous financial and sustainability datasets. The integration of data ingestion, normalization, and synchronization engines allows the system to process large volumes of price, fundamental, and ESG data with differing update frequencies. This architecture supports high-throughput execution in distributed computing environments without manual intervention.

Fourth, the automated construction of sustainability indices and sustainability spread factors provides a consistent computational foundation for return-based sustainability analysis. By generating machine-defined indices directly from segmented datasets, the system avoids reliance on externally defined benchmarks and ensures reproducibility of analytical results across time periods and market regions.

Fifth, the factor exposure estimation engine enables dynamic and time-varying sustainability analysis using statistical estimation techniques such as rolling regression and Kalman filtering. This capability allows the system to detect gradual shifts, abrupt changes, and anomalous behavior in sustainability exposure that cannot be identified using static or holdings-only approaches.

Sixth, the projection and visualization engine provides an efficient mechanism for transforming high-dimensional factor exposure data into a two-dimensional sustainability scoring map. This technical feature facilitates automated drift detection, clustering, and anomaly identification, improving interpretability while preserving computational rigor.

Seventh, the invention improves system interoperability and downstream integration through standardized, machine-readable outputs. Generated indices, factor exposures, sustainability scores, and alerts may be exposed via application programming interfaces, enabling integration with compliance, reporting, and risk management systems.

Finally, the combination of hierarchical data segmentation, simulation-calibrated thresholds, dynamic index construction, and return-based sustainability analysis constitutes a technical improvement in computer-based financial data processing. These advantages collectively enable functionality that is not achievable through manual processes or conventional analytics systems, thereby improving the efficiency, reliability, and scalability of sustainability-oriented data analysis.

The system as described herein includes a processing arrangement and a memory arrangement. Those skilled in the art understand that the processing arrangement can comprise any number of individual processors distributed throughout the architecture of the system and the memory arrangement can comprise any number of individual non-transitory memories distributed throughout the architecture of the system. However, reference to a processor is merely for illustrative purposes. The operations performed by the system may also be represented as a separate incorporated components of a server or may be a modular component coupled to the server, e.g., an integrated circuit with or without firmware. For example, the integrated circuit may include input circuitry configured to receive signals and processing circuitry configured to process the signals and other information. In addition, in some servers, the functionality of the processor is split among two or more processors. In some embodiments, the functionality described for the server may include a cloud implementation such as a set of virtual or hardware servers hosting firmware. The exemplary embodiments may be implemented in any of these or other configurations of a server. The system further includes other components including but not limited to ports to electrically connect the monitoring system to, e.g., other electronic devices and/or power sources, communications components including, e.g., transceivers or ports for wired connections, etc.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a Linux based OS, a mobile device having an operating system such as iOS, Android, etc. In a further example, the exemplary embodiments of the above-described method may be embodied as a computer program product containing lines of code stored on a computer readable storage medium that may be executed on a processor or microprocessor. The storage medium may be, for example, a local or remote data repository compatible or formatted for use with the above noted operating systems using any storage operation.

The above-mentioned engines being applications (e.g., a program) executed by the processing arrangement is only an example. The functionality associated with the engines may also be represented as a separate incorporated component of the monitoring system or may be a modular component coupled to the monitoring system, e.g., an integrated circuit with or without firmware. For example, the integrated circuit may include input circuitry to receive signals and processing circuitry to process the signals and other information. The engines may also be embodied as one application or separate applications.

The system as described above may cause a graphical user interface (GUI) to be provided to a display of a user device. In an embodiment, the user device may comprise a personal computing device (e.g., smartphone, tablet, personal computer, laptop, wearable device such as glasses or a watch, etc.) capable of communicating with a network. The user device includes a processing arrangement and a memory arrangement. The user device may further include input/output (I/O) devices such as hardware components enabling a user to enter inputs, e.g., a keyboard, keypad, mouse, etc. The user device further includes other components including but not limited to ports to electrically connect the user device to, e.g., other electronic devices and/or power sources, communications components including, e.g., transceivers or ports for wired connections, an audio input device, an audio output device, a battery that provides a limited power supply, etc.

The user device may include a display providing a graphical user interface (GUI). In various embodiments, the GUI can include components such as those shown in FIGS. 8-9, 10-11. In an embodiment, the display and the I/O devices may be separate components or integrated together such as a touchscreen. The processing arrangement may include a visualization engine for executing instructions to visualize the GUI. The GUI may include diagrams, charts, maps and other features for visualizing the return-based sustainability analysis as described in detail above. Certain aspects of the GUI may interrelate with other aspects of the GUI, resulting in real-time changes to the GUI. In an embodiment, in response to movement of a computer-generated marker (e.g., cursor) in the GUI, the processor of the user device may display aspects of the return-based sustainability analysis.

The present invention has been described with reference to specific exemplary embodiments thereof. It will, however, be evident that various modifications and changes may be made thereto without departing from the broadest spirit and scope of the present invention as set forth in the disclosure herein. Accordingly, the specification and drawings are to be regarded in an illustrative rather than restrictive sense.

1. A computer-implemented method executed by one or more processors for constructing sustainability indices and sustainability spread factors using heterogeneous financial datasets, the method comprising:
ingesting the heterogeneous financial datasets comprising security price data, corporate fundamental data, and sustainability data;
normalizing and synchronizing the datasets into a time-aligned data structure;
performing automated hierarchical data segmentation on the time-aligned data structure by sequentially partitioning securities into size-based segments, size-style-based segments within each size-based segment, and size-style-sustainability-based segments within each size-style-based segment based on thresholds;
calibrating the thresholds using a simulation-based calibration engine configured to optimize alignment between holdings-based sustainability measures and return-based factor exposures;
constructing sustainability indices for each size-style-sustainability segment; and
computing sustainability spread factors based on differences between sustainability indices.

2. The computer-implemented method of claim 1, wherein the hierarchical data segmentation is dependency-aware such that segmentation at each stage is conditioned on the output of a preceding stage.

3. The computer-implemented method of claim 1, wherein the sustainability data comprises environmental, social, and governance (ESG) data and overall ESG scores normalized to percentile distributions.

4. The computer-implemented method of claim 1, wherein the simulation-based calibration engine executes Monte Carlo simulations over a plurality of synthetic portfolios.

5. The computer-implemented method of claim 4, wherein the calibrated thresholds maximize a correlation metric between holdings-based sustainability scores and return-based sustainability exposures.

6. The computer-implemented method of claim 1, wherein constructing sustainability indices comprises computing market-capitalization-weighted returns for each segment.

7. The computer-implemented method of claim 1, further comprising:
updating the calibrated thresholds periodically in response to changes in underlying dataset characteristics.

8. The computer-implemented method of claim 1, further comprising:
estimating time-varying sustainability factor exposures using a statistical estimation technique comprising window regression, Kalman filter or Bayesian estimation.

9. The computer-implemented method of claim 1, further comprising:
generating a return-based sustainability score using statistical confidence measures derived from factor exposures.

10. The computer-implemented method of claim 1, wherein the heterogeneous datasets comprise daily price data, monthly sustainability data, and periodic fundamental data.

11. The computer-implemented method of claim 1, wherein the size-style-sustainability-based segments include high-sustainability and low-sustainability groups.

12. The computer-implemented method of claim 1, further comprising:
storing the sustainability indices and spread factors in a version-controlled data repository.

13. The computer-implemented method of claim 1, further comprising:
generating machine-readable reports via an application programming interface (API).

14. The computer-implemented method of claim 1, further comprising:
projecting sustainability exposure data into a two-dimensional visualization for drift detection.

15. The computer-implemented method of claim 1, wherein the hierarchical data segmentation reduces correlation leakage between size, style, and sustainability dimensions.

16. The computer-implemented method of claim 1, further comprising:
assigning sustainability alignment categories based on return-based sustainability scores.

17. A computer system comprising one or more processors and non-transitory memory storing instructions that, when executed by the processors, cause the system to perform the following operations:
ingesting multi-source datasets comprising security price data, corporate fundamental data, and sustainability data;
normalizing and synchronizing the datasets into a time-aligned data structure;
performing automated hierarchical data segmentation by sequentially partitioning securities into size-based segments, style-based segments within each size-based segment, and sustainability-based segments within each size-style segment using calibrated thresholds;
calibrating the thresholds using a simulation-based calibration engine configured to optimize alignment between holdings-based sustainability measures and return-based factor exposures;
constructing sustainability indices for each size-style-sustainability segment; and
computing sustainability spread factors based on differences between sustainability indices.

18. The computer system of claim 17, further comprising: a data ingestion engine configured to retrieve heterogeneous datasets from multiple external sources.

19. The computer system of claim 17, further comprising:
a hierarchical data segmentation engine configured to sequentially partition securities across size, style, and sustainability dimensions.

20. The computer system of claim 17, further comprising:
a simulation-based calibration engine configured to execute Monte Carlo simulations in parallel.

21. The computer system of claim 17, further comprising:
an index construction engine configured to dynamically generate sustainability indices.

22. The computer system of claim 17, further comprising:
a factor exposure estimation engine configured to compute return-based sustainability metrics.

23. The computer system of claim 17, further comprising:
a projection engine configured to map multi-dimensional factor exposure vectors into a two-dimensional sustainability scoring map.

24. The computer system of claim 23, wherein the projection engine applies a deterministic projection function or dimensionality-reduction algorithm.

25. The computer system of claim 17, further comprising:
an anomaly detection engine configured to identify sustainability exposure drift.

26. A non-transitory computer-readable medium storing instructions that, when executed by one or more processors, cause the processors to perform operations comprising:
ingesting the heterogeneous financial datasets comprising security price data, corporate fundamental data, and sustainability data;
normalizing and synchronizing the datasets into a time-aligned data structure;
performing automated hierarchical data segmentation on the time-aligned data structure by sequentially partitioning securities into size-based segments, size-style-based segments within each size-based segment, and size-style-sustainability-based segments within each size-syle-based segment based on thresholds;
calibrating the thresholds using a simulation-based calibration engine configured to optimize alignment between holdings-based sustainability measures and return-based factor exposures;
constructing sustainability indices for each size-style-sustainability segment; and
computing sustainability spread factors based on differences between sustainability indices.

27. The non-transitory computer-readable medium of claim 26, wherein the instructions cause the processors to perform automated hierarchical data segmentation using simulation-calibrated thresholds.

28. The non-transitory computer-readable medium of claim 26, wherein the instructions cause the processors to generate sustainability spread factors.
